(19) United States
(12) Patent Application Publication
(10) Pub. No.: US 2019/0344290 A1
(43) Pub. Date: Nov. 14, 2019

(54) FINE MIST SPRAY ACTUATOR AND ORIFICE CUP

(71) Applicant: Rieke Corporation, Auburn, IN (US)

(72) Inventor: Simon Knight, Bridgend Mid Glamorgan (GB)

(21) Appl. No.: 16/411,714

(22) Filed: May 14, 2019

Related U.S. Application Data
(60) Provisional application No. 62/671,103, filed on May 14, 2018.

(51) Int. Cl. B05B 1/02; B05B 15/20

(52) U.S. Cl. CPC B05B 1/02; B05B 15/20

(57) ABSTRACT

A sprayer head includes a domed spin chamber having an S-, Z-, irregular ellipsoid, or other asymmetrical shaped indentation on a post recessed within a dispenser channel. A nozzle cup is mounted onto the post so as to block portions of the dispenser channel and to define two or more tapered spin channels feeding the chamber, thereby improved mixing and fine mist dispersion characteristics. This combination may then be used in combination with any number of known pump mechanisms and containers to create a fine mist dispenser.

### CROSS REFERENCE TO RELATED APPLICATIONS

This application claims priority to U.S. provisional patent application Ser. No. 62/671,103, filed on May 14, 2018, which is incorporated by reference in its entirety.

### TECHNICAL FIELD

The present invention relates generally to sprayer dispensers and, more specifically, to a spray dispenser capable of delivering a fine mist by way of an irregularly shaped swirl chamber formed in the actuator post.

### BACKGROUND

Sprayer heads provide a convenient means for dispensing fluids as a mist or finely dispersed pattern of droplets. These heads are operatively connected with any number of known pump mechanisms to draw fluid from a container and dispense the same.

The head itself may include a spray channel formed in or around a post. A cup is then fitted onto the post so as to define a swirl chamber which mixes and effectively atomizes the fluids prior to being expelled from the outlet positioned downstream from the swirl chamber, and it may take the form of a through-hole formed in the cup.

U.S. Pat. Nos. 8,690,081; 9,364,838; and 9,370,786 all disclose certain types of fine mist sprayers. One or more dispensing channels are between the interface of the post attached to the sprayer head and a separate cup mounted onto the post. A recess within the cup defines a swirl chamber that is fluidically connected to the orifice outlet in the cup. Swirl channels create outlets in a vertical y-axis to deliver fluid into the chamber. When a pump with a pre-compression spring is actuated, the combination produces a fine mist spray.

Notably, these arrangements rely upon the cup being offset from the frusto-conical tip of the post to define a round, cylindrical swirl channel. An arrangement that realized improved performance by differing the shape of the swirl channel would be welcome. Further, an apparatus that provided the swirl features within the surface of the post itself, rather than between the void/offset of the cup and the post might be less prone to potential issues caused by misalignment of these parts.

### SUMMARY OF INVENTION

Sprayer heads provide a convenient means for dispensing fluids as a mist or finely dispersed pattern of droplets. These heads are operatively connected with any number of known pump mechanisms to draw fluid from a container and dispense the same. The sprayer head includes a dispensing channel formed as a horizontal recess within the cylindrical body of the head. A post formed proximate to an inlet that fluidically connects to a pump mechanism projects horizontally with that recess. Spin channels and a spin chamber are formed in surfaces of the post, while a nozzle or orifice cup is mounted over the post so as to seal the channels and chamber. An outlet is formed in the cup and aligns at or near the center of the chamber.

### DESCRIPTION OF THE DRAWINGS

Operation of the invention may be better understood by reference to the detailed description taken in connection with the following illustrations. These appended drawings form part of this specification, and any information on/in the drawings is both literally encompassed (i.e., the actual stated values) and relatively encompassed (e.g., ratios for respective dimensions of parts). In the same manner, the relative positioning and relationship of the components as shown in these drawings, as well as their function, shape, dimensions, and appearance, may all further inform certain aspects of the invention as if fully rewritten herein. Unless otherwise stated, all dimensions in the drawings are with reference to inches, and any printed information on/in the drawings form part of this written disclosure.

In the drawings and attachments, all of which are incorporated as part of this disclosure:

FIG. 1 is a cross sectional side view of the sprayer head attached to a container and pump mechanism according to certain disclosed aspects.

FIG. 2 is an isolated, exploded cross sectional side view of the sprayer head of FIG. 1, with arrow A indicating how the nozzle cup attaches to the sprayer head and, more specifically, the dispenser channel and post formed within the sprayer head.

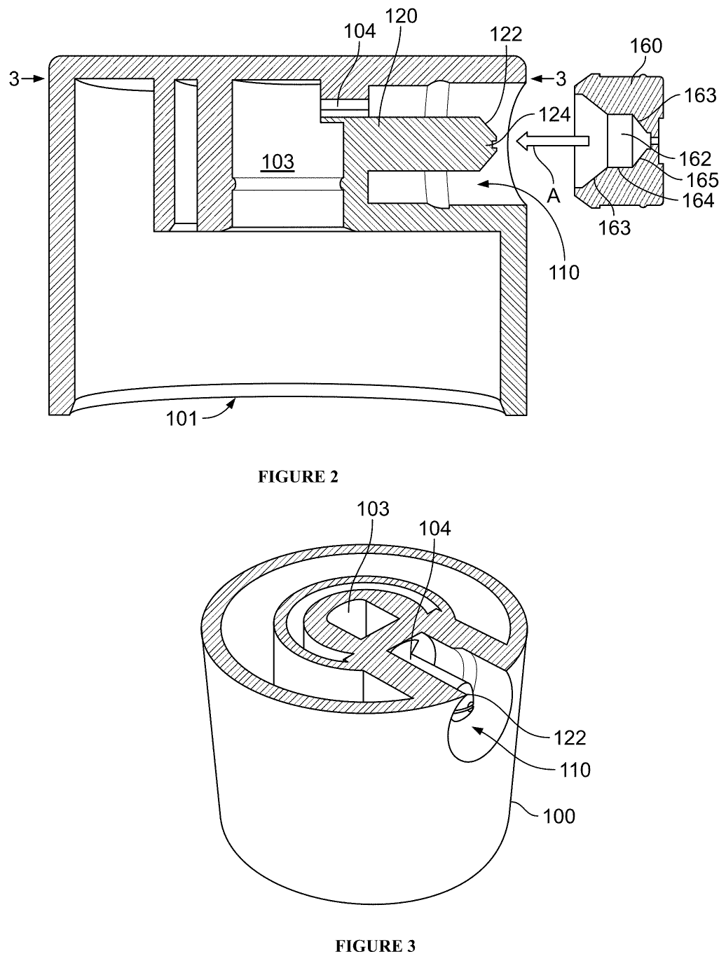

FIG. 3 is a partial, cross sectional perspective view of the sprayer head, taken along line 3-3 in FIG. 2, showing the single inlet channel proximate to the post, which is itself offset on all sides from the dispensing channel formed in the sprayer head so as to form an annular feed for the spin channels.

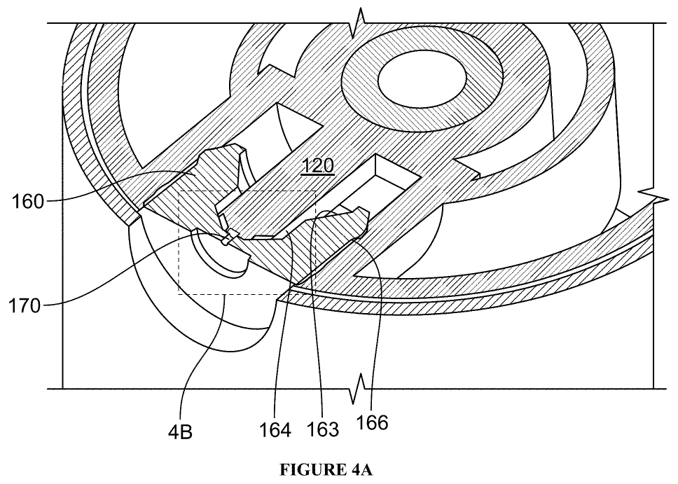

FIG. 4A is a partial, cross sectional perspective view of the sprayer head and nozzle cup, taken along line 4-4 in FIG. 1, highlighting how the spin channels and spin chamber are recessed within the post.

FIG. 4B is an enlarged view of callout 4B from FIG. 4A (although the viewing angle for this perspective view itself has been altered in comparison to FIG. 4A), while FIG. 4C is an enlarged view of callout 4C from FIG. 4B.

FIG. 5A is a partial perspective view of the post positioned within the dispenser channel of the sprayer head and with an S-shaped spin chamber and two spin channels formed on a facing of that post.

FIG. 5B is a schematic view, taken along the axis of the post indicated by arrow B in FIG. 5A, showing the shape of the spin chamber.

FIG. 5C is a schematic view, similar to that of FIG. 5B, illustrating other possible shapes for the spin chamber, although this disclosure contemplates rotating or inverting any of these shapes without departing from the disclosed aspects contemplated herein.

FIG. 6 is a cross sectional side view of an alternative arrangement for the post of the sprayer head originally illustrated in FIG. 1.

FIG. 7A is an isolated perspective view of an alternative arrangement for four spin channels feeding a circular spin chamber in the sprayer head, while FIG. 7B is an enlarged view of callout 7B from FIG. 7A showing the domed shaped of the back wall of the spin chamber.

FIG. 7C is an isolated perspective view of an alternative arrangement for three spin channels in the sprayer head originally illustrated in FIG. 5A.

### DETAILED DESCRIPTION OF EMBODIMENTS

Specific reference is made to the appended claims, drawings, and description, all of which disclose elements of the invention. While specific embodiments are identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

All components should be made of materials having sufficient flexibility and structural integrity, as well as a chemically inert nature. The materials should also be selected for workability, cost, and weight. Common polymers amenable to injection molding, extrusion, or other common forming processes should have particular utility.

The present invention contemplates forming a swirl chamber as a hollow cylindrical recess within the post of the actuator head. More specifically, the post is pin-shaped member is centered within a dispensing channel that is, itself, formed as a circular, cylindrical depression within the sprayer head, A single inlet feeds this dispensing channel, which is directed, by way of a snap-fitted nozzle cup, toward two or more spin channels formed as grooves within the sloping surface of the pin. The spin channels feed into a spin chamber that is also set into the tip of the pin, while the end wall of for that chamber bows inward or outward (i.e., has a concave or convex shape relative to the cylinder defined by the recess). A through hole is centered in the nozzle cup, so as to be positioned over the spin chamber. In this manner, an outlet is created for fluid to exit the sprayer head as a fine mist.

The nozzle or orifice cup couples to the actuator post so as to direct fluid provided into the dispensing channel (by way of a pump mechanism). The cup has a series of inwardly sloping, concentric cones. An outlet is formed concentric to all of the cones. The area immediately adjacent to the outlet may itself be a cone or a flat-wall (i.e., vertically straight).

The post may be rounded on opposing edges, while retaining relatively flatter (or straight-sided) walls orthogonal to these curved sections. The flatter sides cooperate with the inward slope of the orifice cup to define passage ways to deliver fluid to the spin channels. In turn, the spin channels redirect the fluid into the cylindrical recess of the post. However, at the interface where the cup defines the spin channels and chambers, a conical depression leads to a flattened annular area where the outlet is formed at the center of that area.

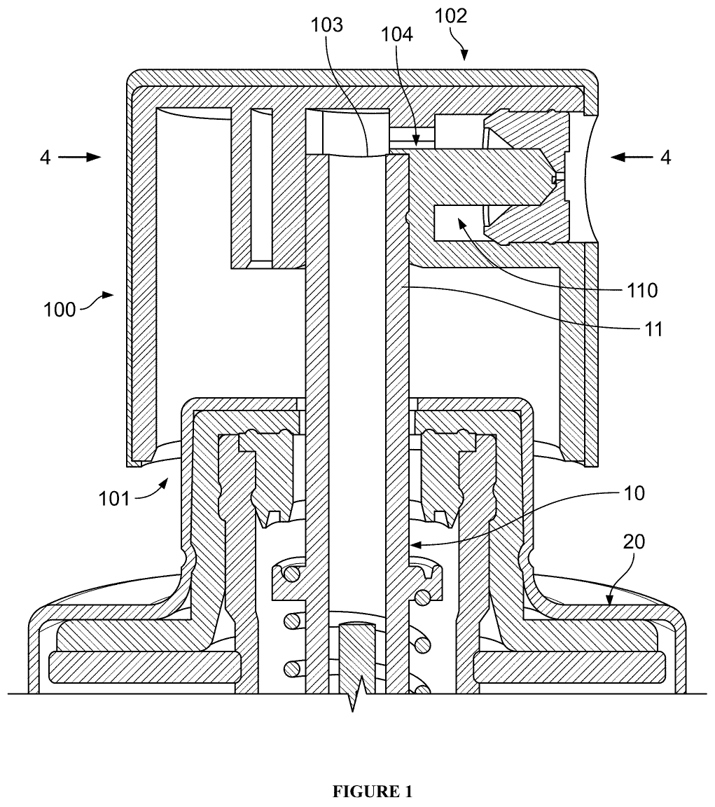

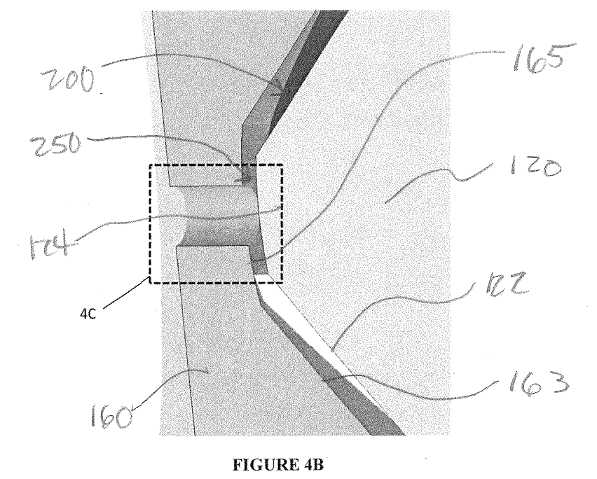

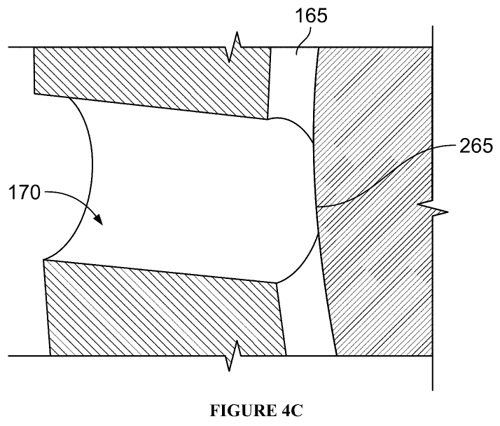

The arrangement above ensures that the spin channels are oriented in the vertical or y-axis or inclined slightly therefrom (see FIGS. 1, 4B, and 6), so as to expel fluid from the channels into the chamber in a manner that induces mixing. To further enhance these effects, the irregular (e.g., concave or convex) sloping of the end wall adds to that effect. In addition, an angle may be imparted to the front wall of the chamber, as it is formed by the orifice cup.

The outlet of the orifice cup should be centered around the midpoint/central axis of the cylindrical recess. The outlet will have a regular circular or curved shape. The cross sectional area of the outlet (taken orthogonally to the dispensing axis) is smaller than the cross sectional area of the cylindrical recess at its largest point (i.e., where the outlets are at their maximum size). This relationship leads to a key feature of the invention—a 4:1 ratio between the area of the recess versus the area of the outlet. The ratio may be as much 5:1 and as little as 3:1. One tenth increments for the numerator and denominator are also disclosed and contemplated herein.

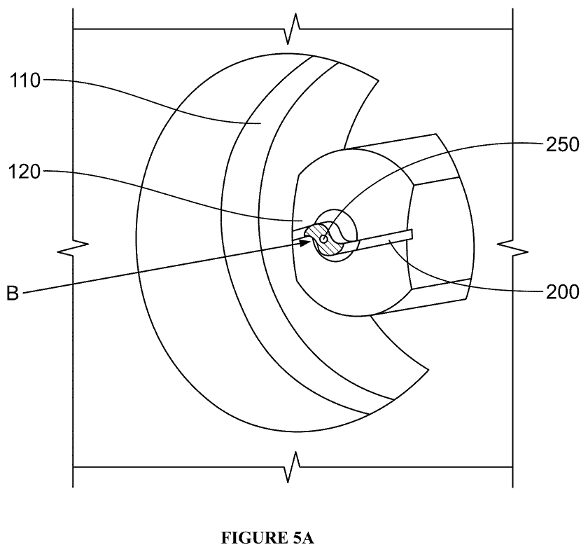

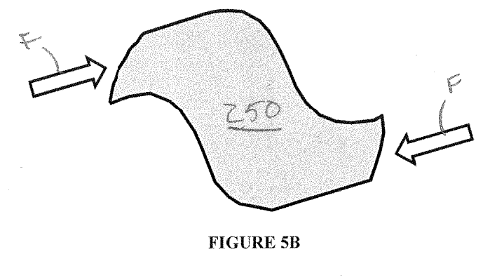

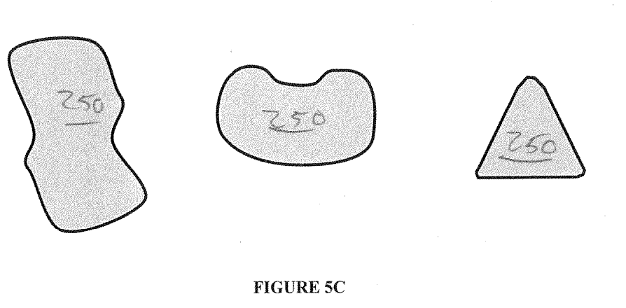

The spin chamber is referred to as a hollow cylindrical recess with irregular shape. This may entail a generally circular or curved longitudinal cylinder with a concave or convex surface enclosing one or both ends. The shape of the chamber may be circular, with the spin channels feeding in at tangential angles. Alternatively, the chamber may have a complex curved, Z-shape, S-shape, or other asymmetrically formed shape along its longitudinal axis (see FIGS. 5A and 5B). Separately, while the actuator post preferably has a convex, curved, and/or conical shape, the opposing top wall of the chamber formed by the nozzle cup is orthogonal to the outlet and effectively flat or straight within the annular area defining the spin chamber immediately adjacent thereto on the nozzle cup. Alternatively, this annular area may be curved or conical so as to mirror the orientation of the end wall in the post.

When a non-circular shape is combined with curving or non-flat end and top walls, the three dimensional shape of the spin chamber will differ substantially from the generally circular cylinder having flat front and end walls, as disclosed in the prior art. In particular, the “irregular” shapes contemplated herein include any of the following: (i) a non-circular profile in the sidewalls of the spin chamber; (ii) a curving (concave or convex) end wall, as defined by the post; and (iii) a curving top wall, as defined by the nozzle cup. These features, and other described herein, lead to a fine mist sprayer that is easier to manufacture and use.

Additionally, the spin channels may be a straight line, a single curve, or tortuous (i.e., multiple curves, such as an S-shape) in shape. Each channel has a cross sectional size (i.e., the area of the channel in a plane that is orthogonal to the direction of flow at that point in the channel) that is slowly reduced as the channel approaches its interface with the spin chamber, so as to a pressure differential that increases the speed/flow of fluid being expelled into the chamber. Thus, the height and/or width of each spin channel will taper downward as it creates an inlet into the spin chamber. Two, three, four, or more channels may be disposed in the actuator post's conical surface. Preferably, the channels are substantially identical in terms of length, taper, and overall size/shape.

Further, the spin channels flow in parallel with the slope of the frusto-conical portion of the post into which they are formed (i.e., along the cone facing) as the channel approaches the chamber interface (i.e., at or near where the cross sectional size of the channel begins to decrease). However, the axis of flow is redirected prior to that interface by the top wall formed in the sprayer cup so as to cause the fluid axis to project parallel to or on a converging pattern with the domed surface forming the end wall of the spin chamber. In this manner, the spin channels introduce fluid into the spin chamber at an angle that is substantially orthogonal (+/−10° from orthogonal) to the dispensing axis defined by the outlet in the nozzle cup.

The selection of these various features enhances mixing and turbulent flow to ensure that the fluid entering the spin chamber is sufficiently mixed. This mixing pattern imparts rotation to the fluid flow along the sidewalls of the chamber. As the fluid rotates or swirls toward the center, a fine mist pattern will be produced upon its expulsion from the spray dispenser via the orifice cup outlet. Equally important, in comparison to the prior art designs noted above, the amount of force required to produce this pattern (i.e., the actuation force of the pump) is relatively low.

While mixing is important, care should be taken to ensure that one channel is not predominant in comparison to the others. That is, to the extent one channel may be disposed closest to the outlet (or otherwise have features that create relatively easier or higher rate flow patterns from that channel), the flow of all channels into the spin chamber should be regulated sufficiently to ensure balanced and even distribution of the fluid throughout the chamber. This regulation may come by way of a restricted profile of each spin channel as it connects to the chamber (e.g., narrowing the outlet surface area so that all channels have substantially the same surface area).

This profile restriction is such that the interface where each channel enters the spin chamber will be designed to be similar for all channels. Thus, the depth/height and/or width of the larger channels will be reduced until its surface area is similar to that of the other, smaller channels. Notably, the area immediately upstream from the interface can be tapered down so as to ensure the efficient operation of the restricted profile.

Any combination of the features described above and/or as shown in the drawings below may be employed. As non-limiting examples, three spin channels with non-tortuous flow paths could be used in combination with an irregularly shaped and recessed spin chamber formed in a frustoconical actuator post could be employed. Other aspects of the invention might only contemplate using one or two of the distinguishing features disclosed herein.

In all cases, the net effect of these features is to induce spin or turbulent flow to the fluids entering the spin chamber itself. In turn, the fluid is then expelled through the cylindrical channel of the orifice of cup thereby creating an evenly dispersed, fine mist pattern emanating from the dispenser. Further, the various shapes and arrangements described herein ensure the actuation of the sprayer presents to the user as a relatively short, smooth downward stroke. Stated differently, whereas other dispensers may require the user to depress the actuator in a lengthy (both in terms of time and distance) actuation stroke, the design disclosed herein requires minimal force and a much shorter downstroke.

Turning to the Figures, sprayer head 100 assembles to any general construction for a pumping mechanism 10. In turn, that mechanism 10 may be crimped or otherwise attached to a container 20 which carries a fluid that is to be dispersed as a fine mist. Notably, the type of pump 10 and container 20 is relatively immaterial, so long as the sprayer head 100 can be coupled to or integrally formed with one or both of these components.

Sprayer head 100 may be formed as a round cylindrical cup. The open end 101 accommodates the pump 10 and container 20, particularly to the extent the pump 10 induces a reciprocating action in which the sprayer head 100 is urged downward. The top end 102 of the head 100 may present as a generally flat surface to facilitate actuation. The head 100 may be formed from plastic and/or coated or finished with any desired exterior finish (e.g., metallic coating, cladding, etc.).

A central duct 103 receives a dispensing end 11 from the pump 10. A single inlet 104 fluidically connects duct 103 to an annular dispensing channel 110. A pin or post 120 is formed within the channel 110. A nozzle or orifice cup 160 is fitted onto the post 120 as indicated by arrow A so as to define spin channels 200 and a spin chamber 250, both as will be described in greater detail below.

Cup 160 includes a cylindrical through-hole 170 which serves as an outlet for the mixed and atomized fluid, which exits the sprayer 100 in a fine mist pattern. Preferably, hole 170 retains a constant circular shape, and it is positioned along the center point (relative to the dispensing axis) of the post 120, the dispensing channel 110, and/or the cup 160 itself. The interior contour of the cup 160 may include one or more sloping 163 and axial 164 regions, along with a terminal wall 165 that is vertical or substantially vertical (i.e., mimicking the contour of the spin chamber end wall 265). Along its outer surface 166, beads, grooves, or other protrusions allow the cup 160 to be snap-fitted to the post 120 and/or the walls of the dispensing channel 110. In this manner, cup 160 seals and defines the flow paths that enable the fine mist spray pattern.

Post 120 may be integrally formed with the structure defining the walls of the dispensing channel 110 in the sprayer head 100. The post 120 is oriented horizontally along the same dispensing axis in which the outlet 170 is itself oriented. At its distal end, post 120 includes a conical section 122 wherein the diameter of the post reduces down toward a flattened tip 124.

A spin chamber 250 is recessed within the tip 124. The shape of this chamber 250 may be circular, S- or Z-shaped, or otherwise irregularly formed, all as described above. The sidewalls of the chamber 250 are integrally formed as part of the tip 124, with breaks to accommodate the inlet/interface between the chamber 250 and the spin channels 200 which feed the chamber 250. An end wall 265 may be flat (i.e., substantially vertical) or, more preferably, imparted with a slight concave or convex dome to promote mixing of the fluid entering the chamber.

Notably, the fluid entering the chamber 250 will be directed at an angle substantially orthogonal to the dispensing axis. This motion, combined with the curvature of the chamber sidewalls, promotes a swirl action which directs the fluid toward outlet 170. When coupled with the restricted profile of the spin channels 200, this combined action ensures the fluid can be and is atomized or reduced to fine mist.

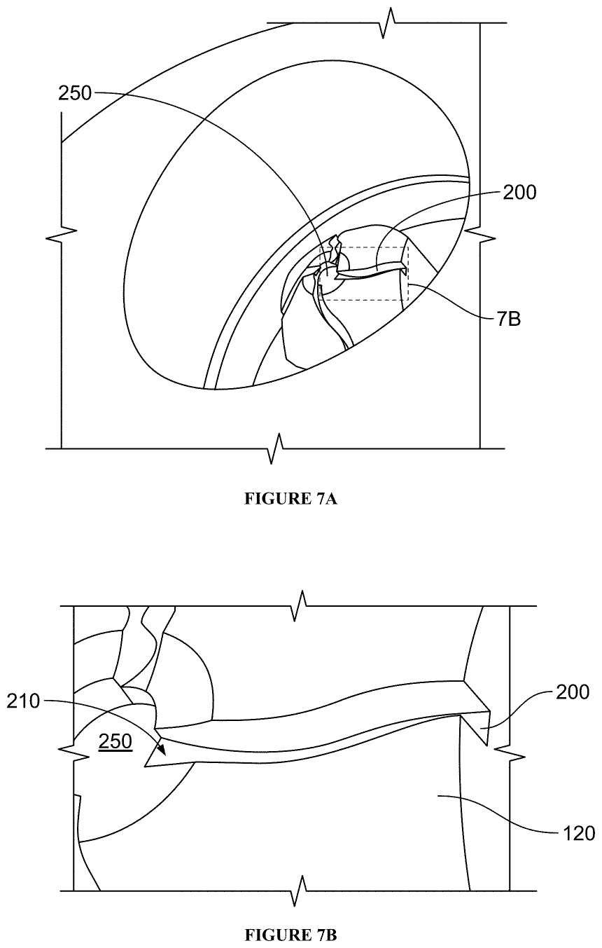

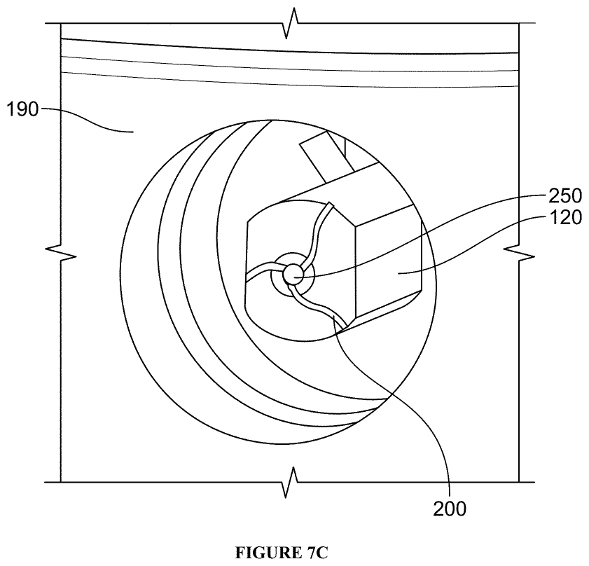

At least two spin channels 200 are at least partially and/or gradually recessed within the conical section 122. These channels may be straight, curved across an arc section of the cone 122, or have a tortuous shape involving a plurality of curves (e.g., an S-shape, as shown in FIGS. 7A and 7B). The channels may gradually cut into the cone 122 at an angle different from the rest of the cone 122. Conversely, along the top edge, the cone section 163 will have a similar slope or angle, although the flattened portion 165 redirects the fluid to its desired flow path.

As best seen in FIG. 7B, each spin channel 200 includes a tapered section 210. This tapered section 210 effectively creates a restricted profile wherein the cross sectional area of the flow channel narrows. This narrowing may be accomplished by changing the height of the channel by imparting a slight change in the angle of the top wall 165 and/or by diverting the angle of the channel within the cone section 122. Additionally or alternatively, the width of the channel can be narrowed/adjusted. This restricted profile is provided immediately prior to the interface (i.e., the inlet/outlet) of the channels 200 and chamber 250. In effect, the narrowing increases pressure and flow of the fluid as it enters the chamber 250, thereby ensuring higher velocity mixing.

The angle at which the channels orient radially to the chamber 250 is illustrated as arrow F in FIG. 5B. Generally speaking, a tangential orientation that is parallel to or even promotes oblique contact with the chamber sidewall is preferred. Further, each of the entry points for the channels 200 should be offset from one another so as to promote swirling within the chamber (rather than providing a series of immediately converging streams). Because the flow paths are already oriented vertically (i.e., orthogonal to the dispensing axis, the sidewalls of the chamber 250 can be integral in promoting mixing. Further the concave or convex shape of end wall 265 and/or top wall 165 may further serve these purposes.

Notably, while FIG. 5C suggests alternative complex, curved shapes, it should be understood that the terms “irregular” and “complex, curved shaped” encompass: ellipsoids: circular, oval, or polygonal cylinders with flat or curved (convex or concaved) ends; serpentine or chevron-shaped chambers; and C-, S-, Z-, N-, U-, M-, J- or L-shaped cylinders with flat or curved ends. A desirable feature is to have a series of sidewalls that accommodate and slowly redirect fluid entering from disparate interfaces and without causing those fluids to immediately collide or meet in the middle of the chamber. In instances where asymmetric or other shapes are employed so that the interfaces cannot be evenly spaced, entry points should be chosen so as to avoid direct or premature crossing of fluid flowpaths. Similarly, shapes that allow for easy centering of the nozzle within the middle of the chamber may also be desirable.

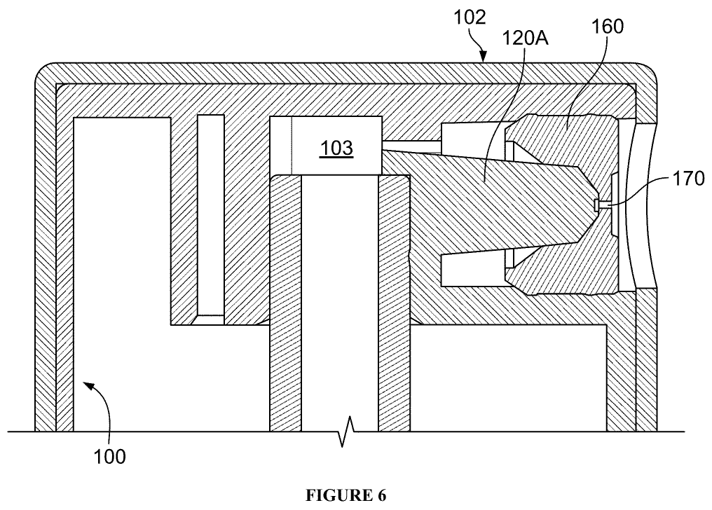

With respect to FIG. 6, it can be seen that the entirety of post 120 may be imparted with a tapered or conical shape. This tapering approach could be reversed, so that the annular dispensing channel 110 grows steadily smaller rather than larger (as shown). It may also be possible to alter (i.e., decrease or increase) the diameter of the channel 110 itself, rather than that of the post 120. In all cases, this change in spacing will promote the desired flow pattern of fluid entering the channels 200 and/or the chamber 250.

Although the present embodiments have been illustrated in the accompanying drawings and described in the foregoing detailed description, it is to be understood that the invention is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof

What is claimed is:

1. A fine mist sprayer comprising:
an actuator head attachable to a container or pump mechanism, said actuator head including an actuator post positioned within a recessed dispensing channel and oriented in a direction substantially parallel to a dispensing axis;
a nozzle cup fitted coaxially onto the actuator post, said nozzle cup having an outlet through-hole oriented along the dispensing axis; and
wherein a spin chamber is formed in a cone-shaped end of the actuator post proximate to the orifice cup and wherein at least two spin channels are formed in an angled surface of the cone-shaped end, each spin channel introducing fluid to the spin chamber at an angle that is substantially orthogonal to the dispensing axis.

2. The sprayer according to claim 1 wherein the spin channels are disposed on opposing sides of the angled surface.

3. The sprayer according to claim 2 wherein the spin chamber has an irregular shape.

4. The sprayer according to claim 3 wherein a maximum cross-sectional surface area of the irregular shape relative to the dispensing axis is between at least three larger than the substantially constant cross-sectional surface area of the outlet.

5. The sprayer according to claim 3 wherein the irregular shape is Z-shaped, S-shaped, or formed as a complex, curved shaped.

6. The sprayer according to claim 1 wherein the spin channels are curved or tortuous.

7. The sprayer according to claim 1 wherein at least three spin channels are provided at circumferentially equidistant points along the angled surface.

8. The sprayer according to claim 1 wherein each spin channel has a restricted profile at a point where fluid is introduced into the spin chamber.

9. The sprayer according to claim 8 wherein the restricted profile comprises a tapered section having a decreasing height of the spin channel.

10. The sprayer according to claim 9 wherein a cross-sectional area of each restricted profile for each spin channel is substantially identical.

11. The sprayer according to claim 1 wherein at least one of the outlet and the recessed dispensing channel is formed as circular cylinder.

12. The sprayer according to claim 1 wherein an end wall of the spin chamber formed by the post is concave or convex.

13. The sprayer according to claim 12 wherein a top wall of the chamber formed by the orifice cup is substantially spaced apart from the end wall at a constant distance relative to an axis formed by the outlet.

14. The sprayer according to claim 1 wherein the spin chamber possesses an ellipsoid shape or symmetric shape.
